(19) United States
(12) Patent Application Publication
(10) Pub. No.: US 2018/0271332 A1
(43) Pub. Date: Sep. 27, 2018

(54) HANDLE DEVICE AND A COOKING APPARATUS INCLUDING THE SAME

(71) Applicant: Tsann Kuen (Zhangzhou) Enterprise Co., Ltd., Zhangzhou (CN)

(72) Inventors: Wen-Yu CHANG, Zhangzhou (CN); Ming-Hsiang LIN, Zhangzhou (CN); Wenbin CHEN, Zhangzhou (CN); Qixiong ZHUANG, Zhangzhou (CN)

(73) Assignee: Tsann Kuen (Zhangzhou) Enterprise Co., Ltd., Zhangzhou (CN)

(21) Appl. No.: 15/928,324

(22) Filed: Mar. 22, 2018

(30) Foreign Application Priority Data
Mar. 24, 2017 (CN) 201720295760.9

(51) Int. Cl. A47J 45/07; A47J 45/10; A47J 36/06

(52) U.S. Cl. CPC A47J 45/07; A47J 36/06; A47J 45/10

(57) ABSTRACT

A handle device adapted to be mounted to a container including a base defining a space, and a cover openably mounted to the base to cover the receiving space. The cover is formed with a through hole spatially communicated with the receiving space. The handle device includes a handle that is adapted to be mounted to the cover and that defines an installation space adapted to be spatially communicated with the through hole, and a receiving box that is detachably received in the installation space and that defines a feeding space spatially communicated with the installation space. A cooking apparatus including the container and the handle device is also provided.

### CROSS-REFERENCE TO RELATED APPLICATION

This application claims priority of Chinese Utility Model Patent Application No. 201720295760.9, filed on Mar. 24, 2017.

### FIELD

The disclosure relates to a handle device and a cooking apparatus including the same.

### BACKGROUND

Referring to FIG. 1, a conventional pot 10 includes a pot body 11, a cover 12 that is openably mounted to the pot body 11 to cover a receiving space 111 of the pot body 11, and a handle 13 connected to the cover 12. The receiving space 111 of the pot body 11 is used for receiving food to be cooked. The cover 12 has a through hole 121 that is spatially communicated with the receiving space 111 of the pot body 11. The handle 13 includes a fixing portion 131 that is fixedly connected to the cover 12 and that defines an ingredient-adding space 134, a covering portion 132 that is connected to the fixing portion 131 and that openably cover the ingredient-adding space 134, and a grip portion 133 that extends horizontally from the fixing portion 131 to be grasped by a user.

While food is being cooked in the receiving space 111, the user may open the covering portion 132 of the handle 13 to expose the ingredient-adding space 134, followed by adding water or seasonings, such as soy sauce, broth, etc. into the ingredient-adding space 134 such that the added ingredients enter the receiving space 111 to mix with the food. Since the cover 12 remains mounted to the pot body 11 during the addition of the ingredients, the added ingredients are prevented from splashing out of the receiving space 111 to contaminate the surroundings or even to scald the user.

However, when cleaning the conventional pot 10, the handle 13 together with the cover 12 has to be cleaned together under a faucet. The cover 12 and the handle 13 may be cumbersome for the user to clean under the faucet, and may cause water splash.

### SUMMARY

Therefore, an object of the disclosure is to provide a handle device and a cooking apparatus including the same that can alleviate at least one of the drawbacks of the prior art.

According to a first aspect of the present disclosure, a handle device is adapted to be mounted to a container, which includes a base that defines a receiving space, and a cover that is openably mounted to the base to cover the receiving space. The cover is formed with a through hole that is spatially communicated with the receiving space.

The handle device includes a handle and a receiving box. The handle is adapted to be mounted to the cover and defines an installation space that is adapted to be spatially communicated with the through hole. The receiving box is detachably received in the installation space and de fines a feeding space spatially communicated with the installation space.

According to a second aspect of the present disclosure, a cooking apparatus includes a container and a handle device mounted to the container.

The container includes abase that defines a receiving space, and a cover that is openably mounted to the base to cover the receiving space. The cover is formed with a through hole that is spatially communicated with the receiving space. The handle device includes a handle that is mounted to the cover and that defines an installation space spatially communicated with the through hole, and a receiving box that is detachably received in the installation space and that defines a feeding space spatially communicated with the installation space.

### BRIEF DESCRIPTION OF THE DRAWINGS

Other features and advantages of the disclosure will become apparent in the following detailed description of the embodiments with reference to the accompanying drawings, of which:

FIG. 1 is a partially exploded perspective view of a conventional pot;

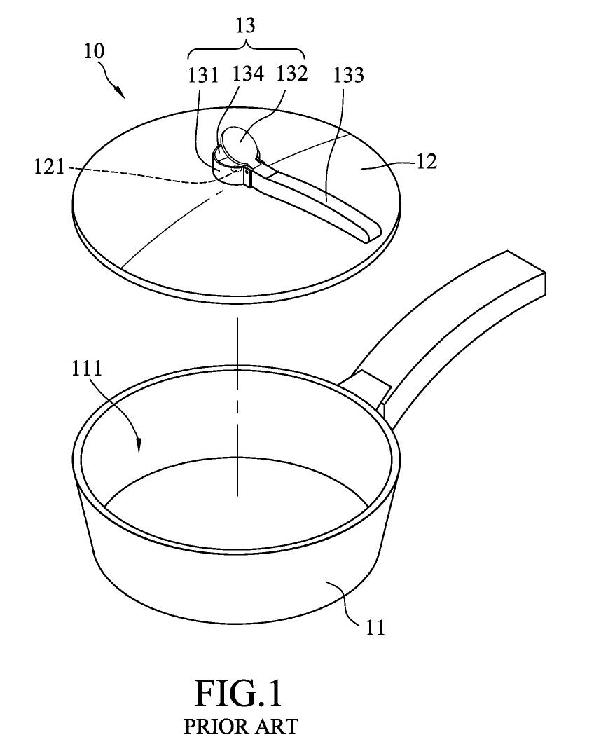

FIG. 2 is an exploded perspective view of a first embodiment of a cooking apparatus according to the present disclosure;

FIG. 3 is an exploded perspective view of a handle device of the first embodiment;

FIG. 4 is a schematic view of the first embodiment with food being cooked therein and a box cover of the first embodiment being opened to expose a feeding space of the first embodiment;

FIG. 5 is a schematic view showing seasonings being added into the first embodiment;

FIG. 6 is a schematic view of the first embodiment, showing the box cover covering the feeding space;

FIG. 7 is an exploded perspective view of a second embodiment of the cooking apparatus according to the present disclosure;

FIG. 8 is a schematic view of the second embodiment; and

FIG. 9 is a schematic view of a third embodiment of the cooking apparatus according to the present disclosure.

### DETAILED DESCRIPTION

Before the disclosure is de scribed in greater detail, it should be noted that where considered appropriate, reference numerals or terminal portions of reference numerals have been repeated among the figures to indicate corresponding or analogous elements, which may optionally have similar characteristics.

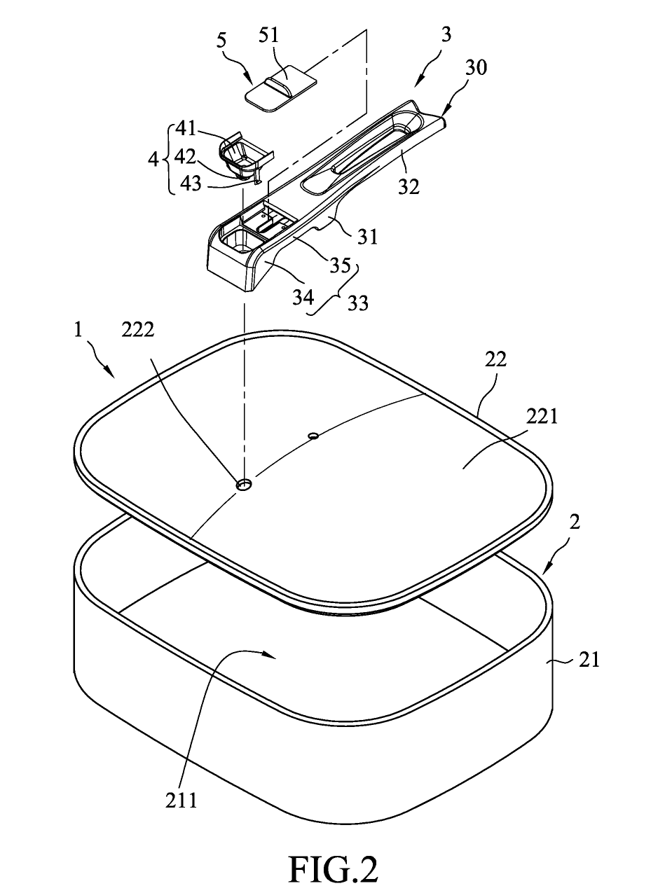

FIGS. 2 to 4, a first embodiment of a cooking apparatus according to the present disclosure includes a container 2 and a handle device 3 mounted to the container 2. The container 2 includes a base 21 that defines a receiving space 211, and a cover 22 that is openably mounted to the base 21 to cover the receiving space 211. The cover 22 has a top surface 221 that is non-flat. In this embodiment, the top surface 221 is convex upwardly. The cover 22 is formed with a through hole 222 that is spatially communicated with the receiving space 211.

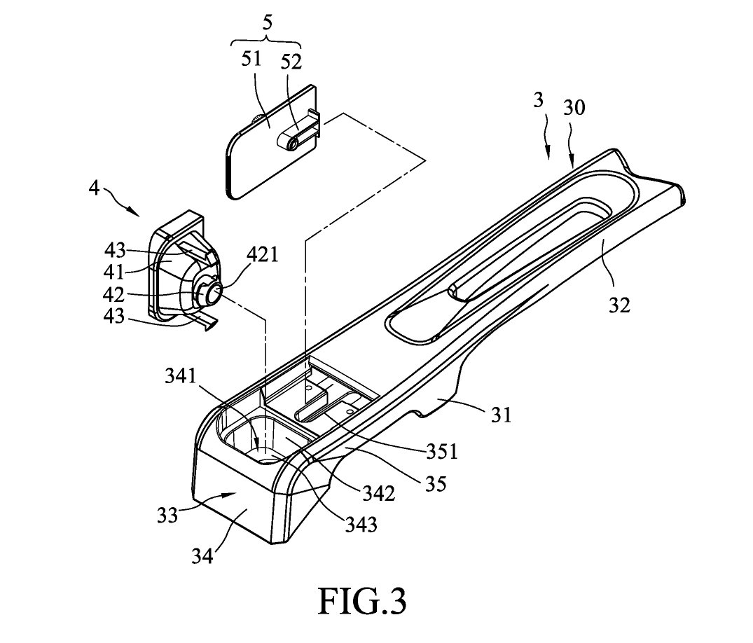

Referring to FIGS. 3 to 5, the handle device 3 includes a handle 30 that is mounted to the cover 22, a receiving box 4 that is detachably mounted to the handle 30, and a box cover 5 that is mounted on the handle 30 and that is slidable on the handle 30.

The handle 30 has a connecting portion 31 that is detachably connected to the cover 22, a grip portion 32 that extends from an end of the connecting portion 31 and that is adapted to be grasped by a user, and an extending portion 33 that extends from an opposite end of the connecting portion 31. In this embodiment, the connecting portion 31 of the handle 30 is located at the center of the top surface 221 of the cover 22, and is connected to the cover 22 via threaded engagement. The grip portion 32 of the handle 30 is spaced apart from the top surface 221 of the cover 22, allowing the user to grasp the grip portion 32 of the handle 30 to move the cover 22. The extending portion 33 of the handle 30 has an abutting section 34 that is spaced apart from the connecting portion 31 and that abuts against the top surface 221 of the cover 22, and a connecting section 35 that is connected between the abutting section 34 and the connecting portion 31. The abutting section 34 has a surrounding wall 342 that defines an installation space 341 spaced apart from the top surface 221 of the cover 22, and an inward flange 343 that extends inwardly from a lower inner portion of the surrounding wall 342. A bottom surface of the surrounding wall 342 is concave upwardly to tightly abut against the convex top surface 221 of the cover 22. The inward flange 343 is formed with a central through hole 345 that is spatially communicated with the installation space 341, and two side through holes 344 that are respectively located at two opposite sides of the central through hole 345 and that are spatially communicated with the installation space 341. A distance between a center of the abutting section 34 and a center of the connecting portion 31 is larger than 30 mm. The connecting section 35 is spaced apart from the cover 22, and is formed with an engaging groove 351 having an opening facing toward the grip portion 32. The box cover 5 is slidable on the connecting section 35.

The receiving box 4 is detachably received in the installation space 341 and defines a feeding space 44 spatially communicated with the installation space 341. Specifically, the receiving box 4 includes a box body 41 that is detachably received in the installation space 341 and that is located above the inward flange 343, a tube body 42 that extends downwardly from the box body 41 and that defines a tube passage 421 having a lower end outlet 422 registered with the through hole 222, and two hook bodies 43 that respectively extend downwardly from two sides of the box body 41 and that respectively pass through the side through holes 344 to be hooked on the inward flange 343. The box body 41 and the tube body 42 cooperatively define the feeding space 44. The feeding space 44 is spatially communicated with the receiving space 211 through the installation space 341 and the through hole 222.

The box cover 5 includes a box cover plate 51 that is generally rectangular, and a box cover block 52 that detachably engages the engaging groove 351 such that the box cover 5 is slidably disposed on the connecting section 35.

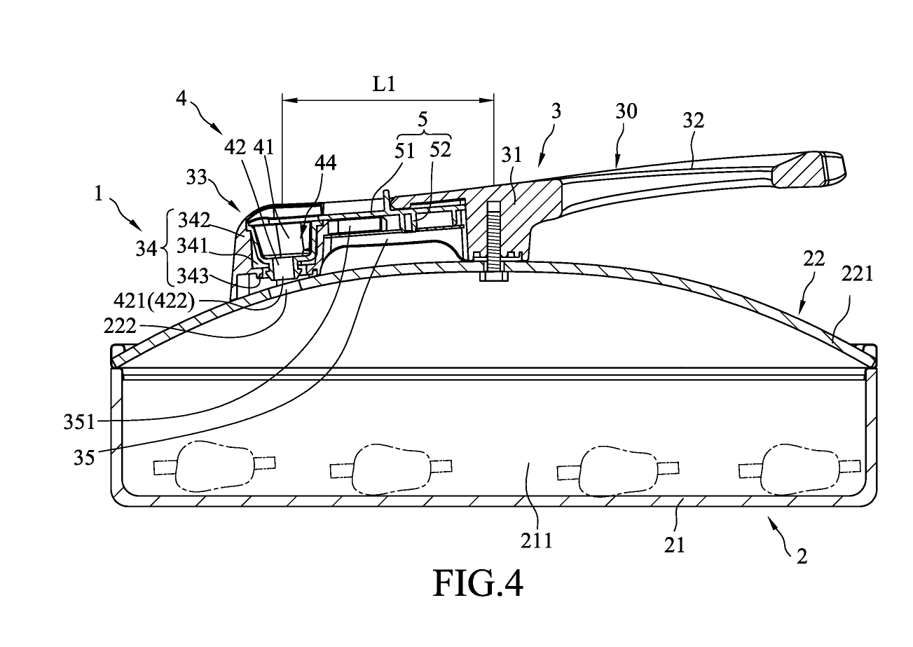

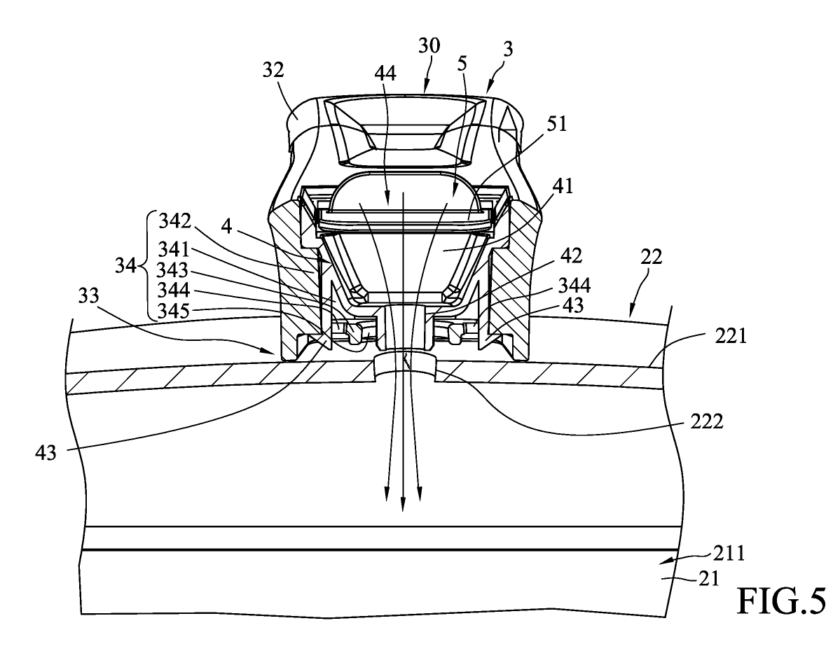

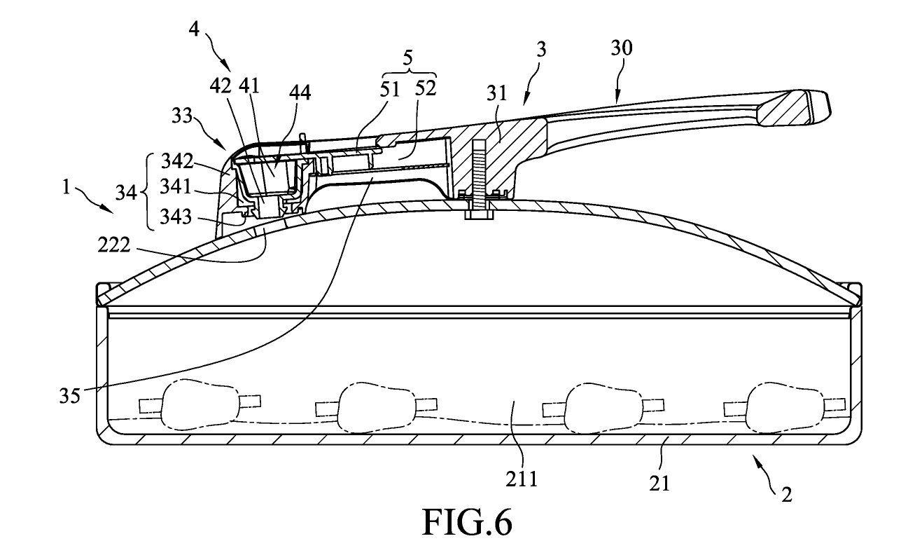

Referring to FIGS. 4 to 6, food, such as chicken can be fried in the receiving space 211 of the base 21, followed by covering the receiving space 211 with the cover 22. Afterwards, seasonings, such as wine, soy sauce, sesame oil, etc. can be added into the feeding space 44. The seasonings enter the receiving space 211 through the tube passage 421 of the tube body 42 and the through hole 222 of the cover 22 (see the arrows shown in FIG. 5), allowing the seasonings to be mixed with the food. The box cover 5 can be pushed by the user to cover the feeding space 44 (see FIG. 6), allowing the food and the seasonings to be cooked in the sealed receiving space 211.

The user can add the seasonings into the receiving space 211 without removing the cover 22, which is convenient and safe, since the cover 22 prevents the food or seasonings from splashing out of the receiving space 211. Furthermore, since the distance between the center of the abutting section 34 and the center of the connecting portion 31 is larger than 30 mm, the user grasping the grip portion 32 is prevented from being scalded by steam escaping from the feeding space 44. The center of the abutting section 34 and the center of the connecting portion 31 may be center of gravity or center of mass.

After cooking, the receiving box 4 can be removed from the handle 30 by pushing the hook bodies 43 toward each other to allow for removal of the hook bodies 43 from the inward flange 343, such that the receiving box 4 can be cleaned independently. After long term use of the cooking apparatus 1, only the receiving box 4 is needed be replaced without changing the container 2 or the whole handle device 3.

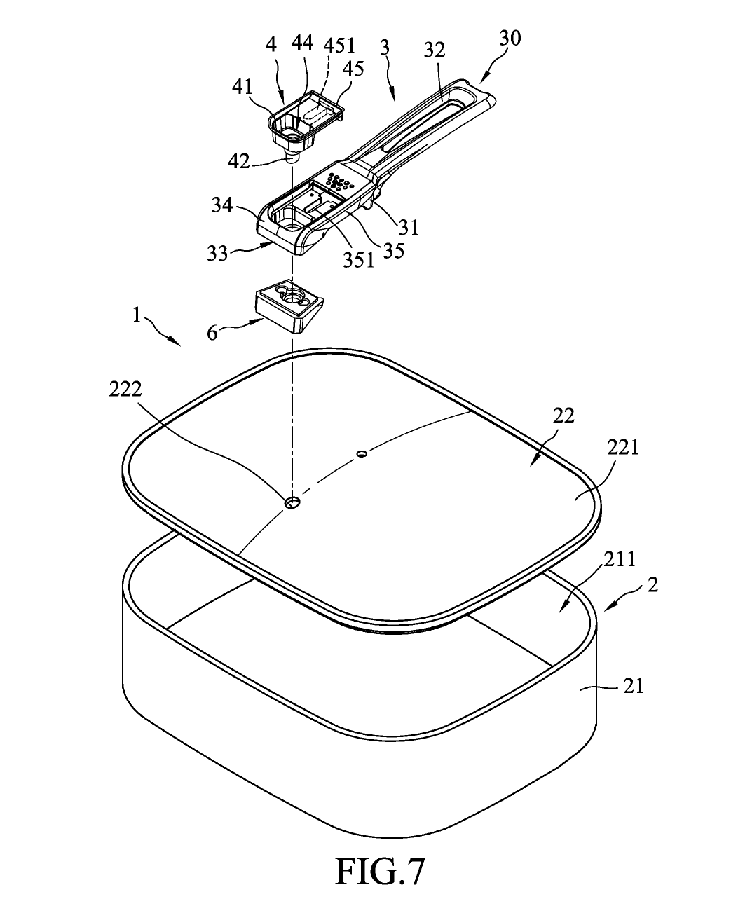

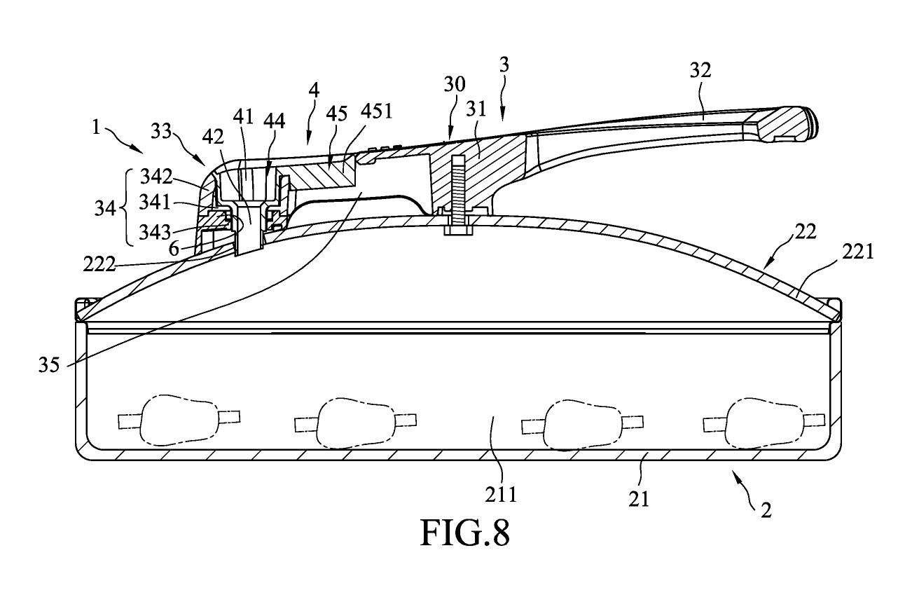

Referring to FIGS. 7 and 8, a second embodiment of the cooking apparatus 1 has a structure modified from that of the first embodiment. In the second embodiment, the box cover 5 is omitted, and the handle device 3 further includes a cushion member 6. The bottom surface of the surrounding wall 342 is flat. The cushion member 6 is connected to the bottom surface of the surrounding wall 342 of the extending portion 33 and abuts against the top surface 221 of the cover 22. The receiving box 4 further includes a seat body 45 that extends from the box body 41, and that includes a seat block 451 detachably engaging the engaging groove 351 of the connecting section 35. The hook bodies 43 of the receiving box 4 are omitted in the second embodiment, and the receiving box 4 is made of heat insulation plastic material. The tube body 42 of the receiving box 4 extends through the through hole 222 of the cover 22.

Since the receiving box 4 of the second embodiment is mounted to the handle device 3 through engagement between the seat block 451 and the engaging groove 351 and omits the hook bodies 43, it can be more easily mounted to or disengaged from the handle device 3. The tube body 42 extending through the through hole 222 ensures that the added seasonings enter the receiving space 211 without being left on the top surface 221 of the cover 22, and positions the abutting section 34 of the handle device 3 relative to the cover 22. The cushion member 6 ensures the surrounding wall 342 having the flat bottom surface can be easily positioned relative to the convex top surface 221 of the cover 22.

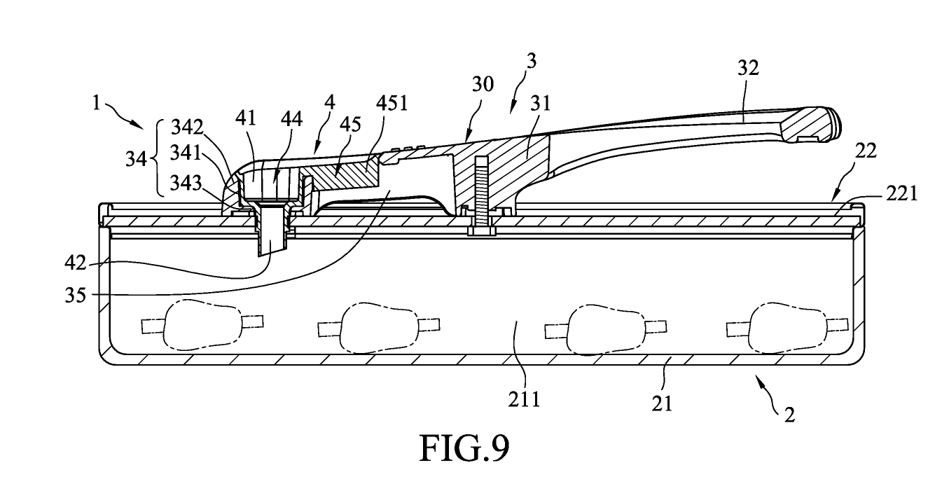

Referring to FIG. 9, a third embodiment of the cooking apparatus 1 has a structure modified from that of the second embodiment. In the third embodiment, the top surface 221 of the cover 22 is flat, and the cushion member 6 is omitted. The flat bottom surface of the surrounding wall 342 fittingly abuts against the top surface 221 of the cover 22.

In the description above, for the purposes of explanation, numerous specific details have been set forth in order to provide a thorough understanding of the embodiments. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A handle device adapted to be mounted to a container, the container including a base that defines a receiving space, and a cover that is openably mounted to the base to cover the receiving space, the cover being formed with a through hole that is spatially communicated with the receiving space, said handle device comprising:
a handle that is adapted to be mounted to the cover and that defines an installation space adapted to be spatially communicated with the through hole; and
a receiving box that is detachably received in said installation space and that defines a feeding space spatially communicated with said installation space.

2. The handle device as claimed in claim 1, wherein said receiving box includes a box body that is detachably received in said installation space, and a tube body that extends downwardly from said box body and that defines a tube passage having a lower end outlet adapted to be registered with the through hole, said box body and said tube body cooperatively defining said feeding space.

3. The handle device as claimed in claim 2, wherein said receiving box is made of heat insulation material.

4. The handle device as claimed in claim 1, further comprising a box cover that is mounted on said handle to cover said feeding space of said receiving box and that is operable to uncover said feeding space.

5. The handle device as claimed in claim 4, wherein said box cover is slidable on said handle to uncover said feeding space.

6. The handle device as claimed in claim 1, the cover having a top surface that is flat, wherein said handle has a connecting portion that is detachably connected to the cover, a grip portion that extends from an end of said connecting portion and that is adapted to be grasped by a user, and an extending portion that extends from an opposite end of said connecting portion, said extending portion defining said installation space and abutting against the top surface of the cover.

7. The handle device as claimed in claim 1, the cover having a top surface that is non-flat, wherein said handle has a connecting portion that is detachably connected to the cover, a grip portion that extends from an end of said connecting portion and that is adapted to be grasped by a user, and an extending portion that extends from an opposite end of said connecting portion, said extending portion defining said installation space and being spaced apart from the top surface of the cover, said handle device further comprising a cushion member that is connected to a bottom surface of said extending portion and that abuts against the top surface of the cover.

8. The handle device as claimed in claim 7, wherein said extending portion of said handle has an abutting section that defines said installation space, and a connecting section that is connected between said abutting section and said connecting portion, a distance between a center of said abutting section and a center of said connecting portion being larger than 30 mm.

9. The handle device as claimed in claim 6, wherein said extending portion of said handle has an abutting section that defines said installation space, and a connecting section that is connected between said abutting section and said connecting portion, a distance between a center of said abutting section and a center of said connecting portion being larger than 30 mm.

10. A cooking apparatus comprising a container and a handle device mounted to said container, said container including a base that defines a receiving space, and a cover that is openably mounted to said base to cover said receiving space, said cover being formed with a through hole that is spatially communicated with said receiving space, said handle device including a handle that is mounted to said cover and that defines an installation space spatially communicated with said through hole, and a receiving box that is detachably received in said installation space and that defines a feeding space spatially communicated with said installation space.

11. The cooking apparatus as claimed in claim 10, wherein said receiving box includes a box body that is detachably received in said installation space, and a tube body that extends downwardly from said box body and that defines a tube passage having a lower end outlet registered with said through hole, said box body and said tube body cooperatively defining said feeding space.

12. The cooking apparatus as claimed in claim 11, wherein said receiving box is made of heat insulation material.

13. The cooking apparatus as claimed in claim 10, wherein said handle device further includes a box cover that is mounted on said handle to cover said feeding space of said receiving box and that is operable to uncover said feeding space.

14. The cooking apparatus as claimed in claim 13, wherein said box cover is slidable on said handle to uncover said feeding space.

15. The cooking apparatus as claimed in claim 10, wherein said cover has a top surface that is flat, said handle having a connecting portion that is detachably connected to said cover, a grip portion that extends from an end of said connecting portion and that is adapted to be grasped by a user, and an extending portion that extends from an opposite end of said connecting portion, said extending portion defining said installation space and abutting against said top surface of said cover.

16. The cooking apparatus as claimed in claim 10, wherein said cover has a top surface that is non-flat, said handle having a connecting portion that is detachably connected to said cover, a grip portion that extends from an end of said connecting portion and that is adapted to be grasped by a user, and an extending portion that extends from an opposite end of said connecting portion, said extending portion defining said installation space and being spaced apart from said top surface of said cover, said handle device further including a cushion member that is connected to a bottom surface of said extending portion and that abuts against said top surface of said cover.

17. The cooking apparatus as claimed in claim 16, wherein said extending portion of said handle has an abutting section that defines said installation space, and a connecting section that is connected between said abutting section ands aid connecting portion, a distance between a center of said abutting section and a center of said connecting portion being larger than 30 mm.

18. The cooking apparatus as claimed in claim 15, wherein said extending portion of said handle has an abutting section that defines said installation space, and a connecting section that is connected between said abutting section ands aid connecting portion, a distance between a center of said abutting section and a center of said connecting portion being larger than 30 mm.
